(19) United States
(12) Patent Application Publication
(10) Pub. No.: US 2020/0257571 A1
(43) Pub. Date: Aug. 13, 2020

(54) RELATIONSHIP DRIVEN WORKLOAD PLACEMENT FOR COMPUTING CLUSTERS

(71) Applicant: HEWLETT PACKARD ENTERPRISE DEVELOPMENT LP, Houston, TX (US)

(72) Inventors: Manish Kulkarni, Bangalore (IN); Shashank Admane, Bangalore (IN); Prabhanjan Gururaj, Bangalore (IN)

(21) Appl. No.: 16/274,888

(22) Filed: Feb. 13, 2019

(51) Int. Cl. G06F 9/50; G06N 5/00

(52) U.S. Cl. CPC G06F 9/5083; G06F 9/5077; G06F 2209/501; G06F 2209/505; G06F 2209/508; G06N 5/003

(57) ABSTRACT

Methods and systems are provided for the assignment and placement of at least two related workloads, including a first workload and a second workload, to one or more computing nodes in a computing cluster containing at least three computing nodes. In one example, a method includes assigning the first workload to a first computing node based upon a functional relationship between the first workload and the second workload to produce a first assignment, assigning the second workload to a second computing node based upon the functional relationship between the first workload and the second workload to produce a second assignment, and placing the first workload in the first computing node and placing the second workload in the first computing node based on the first and second assignments.

### BACKGROUND

In various industries, such as providing on-line services and sales, it may be important to provide a computing platform that is both robust and fault tolerant such that no single failure causes a shutdown of the entire computing platform. To address this issue, a “cluster” of interrelated computing devices may be used in a way such that various tasks handled by a first computing device may be assigned to a second computing device should the first computing device fail for some reason.

### BRIEF DESCRIPTION OF THE DRAWINGS

Various examples of this disclosure that are proposed as examples will be described in detail with reference to the following figures, wherein like numerals reference like elements, and wherein:

FIG. 1 depicts an example processing system capable of processing a number of different workloads using a cluster of computing nodes.

FIG. 2 is a block diagram that depicts various processes and other components that may be incorporated into a computing node.

FIG. 3 is a block diagram of a workload managing device capable of managing the placement of different workloads among a cluster of computing nodes.

FIGS. 4A-4D are related flowcharts of a method usable to manage the placement of different workloads among a cluster of computing nodes.

FIGS. 5A-5D depict an example device having executable computer code usable to execute the method of FIGS. 4A-4D.

FIGS. 6-13 depict a variety of workload placement scenarios based on the disclosed methods and systems.

### DETAILED DESCRIPTION

The methods and systems disclosed below may be described generally, as well as described in terms of specific examples. For instances where references are made to detailed examples, it is noted that any of the underlying principles described are not to be limited to a single example but may be expanded for use with any of the other methods and systems described herein as will be understood by one of ordinary skill in the art unless otherwise specifically stated.

For the purposes of this disclosure, the following definitions apply.

The term “process” refers to a set of instructions usable on one or more machines, such as a computer, that performs a useful activity.

The term “activity” refers to any task/endeavor that may be found useful and/or desirable and that may be performed, in whole or in part, by a process. An activity may thus include, for example, email delivery, medical diagnoses, fraud detection, gaming, providing an on-line sales platform, and so on.

The term “workload” refers to a single process or any number of related processes designed to perform one or more activities, or a portion of a single activity. By way of example, a first workload may consist of a number of back-end processes (e.g., inventory control) used to support an on-line sales platform. Similarly, a second workload may consist of a number of processes used to support a Graphic User Interface (GUI) that both displays various forms of data while receiving user instructions.

Workloads may be considered “related” (or have a “relationship”) if they have some form of functional relationship(s) with one another. By way of example, the second workload discussed above may be related (i.e., have a “relationship”) to the first workload should the second workload provide an online GUI for an activity provided by the first workload.

The term “manager” refers to some form of software-based process capable of being run by a computing device that performs a number of specific or otherwise-identified management function(s), such as the organization and/or coordination of resources to perform a number of activities. Alternatively, a “manager” may refer to a computing device that incorporates such software-based process.

The term “computing node” (or “node”) as used herein refers to some form of computing system capable of supporting a number of workloads. In various examples the term “computing node” includes, but is not limed to, computers, computer-based servers, a network of computer-based servers, devices augmented with specialized math and/or graphics processors, and so on.

The term “migration” refers to a number of processes (e.g., a workload) being moved from one physical device, e.g., a computing node, to another device typically (but not necessarily) with little or no disruption in service.

The term “cluster of computing nodes” (or “computing cluster”) refers to a number of communicatively-coupled computing nodes that are capable of performing separate workloads. By way of example, two separate workloads may be distributed among any one or two computing nodes in a computing cluster having three or more separate computing nodes.

The term “failover” refers to the act of migrating (i.e., assigning and placing) a workload from a first computing node to a redundant or backup computing node in response to some form of failure of the first computing node. Unless otherwise stated, a “failover” is to be consider an automatic response to a computing note failure. This is in contrast to a “switchover,” which requires some form of human interaction to migrate a workload from one computing note to a second computing note. This is also in contrast to “automated with manual approval,” which refers to a failover reconfiguration that runs automatically once a user acknowledges the underlying failover and approves of the resulting reconfiguration.

It is to be appreciated that failover may be automated by the use of some form of “watchdog” and/or “heartbeat” system that connects multiple systems. In various examples, as long as a particular computing node provides a regular “pulse,” “heartbeat,” or other appropriate signal to some form of systems management device, the hardware of the computing node may be considered healthy. Further, for the purposes of this disclosure, monitoring (“watchdog”) processes may be used to monitor the various processes that constitute a particular workload. By way of example, it may be the responsibility of a short interrupt-based routine to periodically monitor three separate processes constituting a workload to determine whether or not each of such workload processes has malfunctioned.

The term “failback” generally refers to a restoration of workload to a particular computing node once a previous failure of the computing node is resolved. However, for the purposes of this disclosure, the term “failback” may refer to any reorganization of workloads in a computing cluster when one or more computing nodes that previously failed become again available to process workloads.

This disclosure proposes workload assignment and placement approaches related to cluster-based solutions that take the nature of various relationships among workloads into consideration. An “assignment manager,” for example, may provide and/or apply a number of heuristic rules that allow for an improved and/or optimized placement of related workloads among a cluster of computing nodes. A “placement manager” is an entity associated with an assignment manager that is responsible for the placement of workloads according to assignments dictated by the assignment manager while maintaining the defined relationships among workloads. Thus, the disclosed methods and systems can efficiently handle node failures without compromising the availability of workloads and the relationships defined between them. The methods and systems also manage the balancing of workloads among computing nodes such that computing resources are appropriately, if not optimally, distributed among available computing nodes.

An appropriate example balancing rule may be a rule assigning the most computational-intensive workload to the most computationally-capable computing node available at any given time, which has an effect of assigning workloads based on relative computing usage. As another example balancing rule, it may be useful to structure a rule that assigns computing resources such that a first workload will support the instantaneous computing requisites of a related second workload while at the same assign sufficient computing resources such that the second workload will support the instantaneous computing requisites of the first workload. However, it is to be appreciated that this “balancing” of computing resources may be based upon a number of criteria beyond instantaneous processing issues. For instance, “balancing” may include the balancing of average workload processing over a given time period, balanced to avoid subjective issues (e.g., to limit on-line delay when interfacing with human users), or balanced according to any other useful or desirable criteria.

Still another example balancing rule may include a rule assigning different workloads to different nodes when possible so as to assure some distributed processing, as opposed to assigning multiple workloads to a single computing node.

While workload balancing may be accomplished using a set of heuristic rules, workload balancing may also be accomplished using some form of scoring system related to individual workload and overall system performance. Different workload balancing rules may result in how workload placement is evaluated, i.e., “scored.” By way of example, applying an objective to assign the most computationally-intensive workloads to the most computationally-capable available computing nodes, producing and using a “score” of each possible combination of workload assignments becomes highly manageable. For instance, applying this rule in a scenario where two workloads of different computational bandwidth are to be distributed in a cluster of four computing nodes having different processing capability, there may be no more than six separate scores to consider assuming that the two workloads are not to be run on a single node.

The ideal of balancing, however, may not be limited to applying any single rule or objective at one time. For instance, using a weighted parametric equation based on number of desirable objectives and/or rules, it may be possible to “score” an individual assignment of a workload to a given computing node as well as “score” an entire set of workload assignments to any set of computing nodes. By way of example, if there are two related workloads that may be processed by any one or two computing nodes of a cluster of four computing nodes, then at most a total of sixteen (16) scores need be addressed. The number of scores to be considered naturally decreases upon the failure of one or more individual nodes. For instance, using the example immediately above if two of the four computing nodes fail, then at most four (4) scores need to be considered when considering workload assignments.

Further, scoring may be based on past experience using different workload placements while objectively and/or evaluating (i.e., “scoring”) overall system performance for each workload placement combination.

Still further, it may be useful to consider completely different scoring criteria based on different events. For example, a first set of scoring criteria may be beneficial to consider upon initial workload placement, a second set of scoring criteria may be considered for failover events, and a third set of scoring criteria may be considered for failback events.

In view of the different approaches there may be to scoring workload assignments, it is to be appreciated that the form of a “score” may vary widely. In various examples a “score” may be represented by a numeric value. In other examples a “score” may be represented by a rule giving preference to one arrangement of workloads over one or more other arrangements of workloads. However, in still other examples the notion of a “score” may take any form so long as such a form can provide some indication of workload arrangement preference.

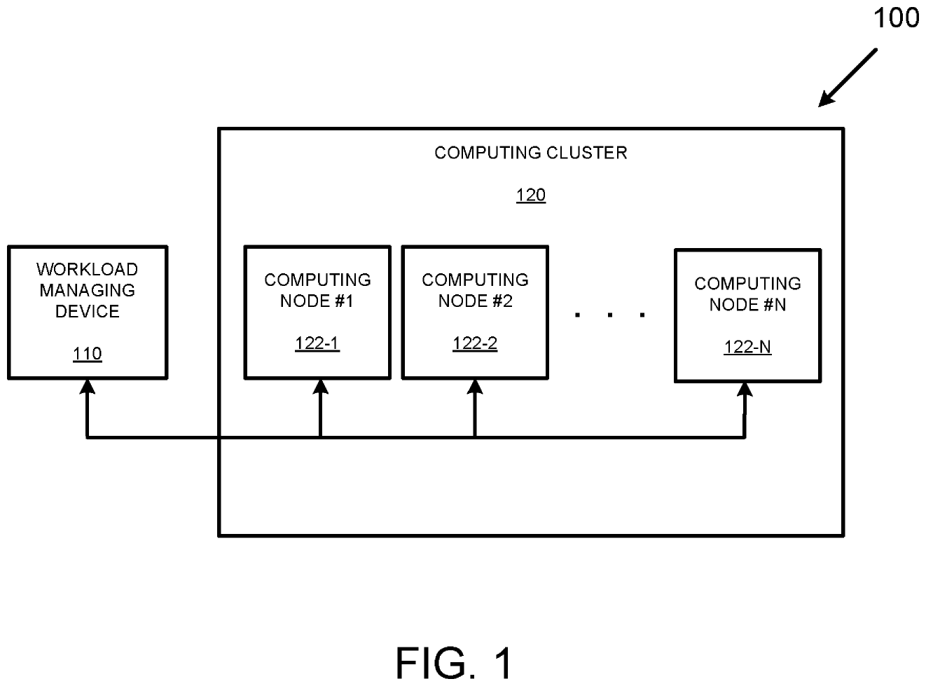

Turning now to the drawings, FIG. 1 depicts an example processing system 100 capable of processing a number of different workloads that together perform some form of activity. As is shown in FIG. 1, the example processing system 100 includes a workload managing device 110 communicatively coupled to a computing cluster 120 consisting of a number of computing nodes {122-1, . . . 122-N}.

While the example workload managing device 110 is depicted as a separate device in FIG. 1, it should be appreciated that, in various other examples, the workload managing device 110 may be incorporated into one or more of the computing nodes {122-1, . . . 122-N}. That is, the workload managing device 110 may take the form of any number of software/firmware routines running on any individual computing node {122-1, . . . 122-N}, or alternatively may take the form of any number of software/firmware routines running on any two or more of the individual computing nodes {122-1, . . . 122-N}.

In operation, the workload managing device 110 may manage the individual placement of individual workloads among the computing nodes {122-1, . . . 122-N} based on any number of criteria, including criteria that takes the relationships between different workloads into account and criteria that does not take the relationships between different workloads into account. In the case of failover and failback events, the workload managing device 110 may manage the assignment and placement (i.e., the migration) of any number of workloads between the computing nodes {122-1, . . . 122-N} in an effort to maintain some activity performed by the computing cluster 120 while attempting to balance workload processing among the available computing nodes.

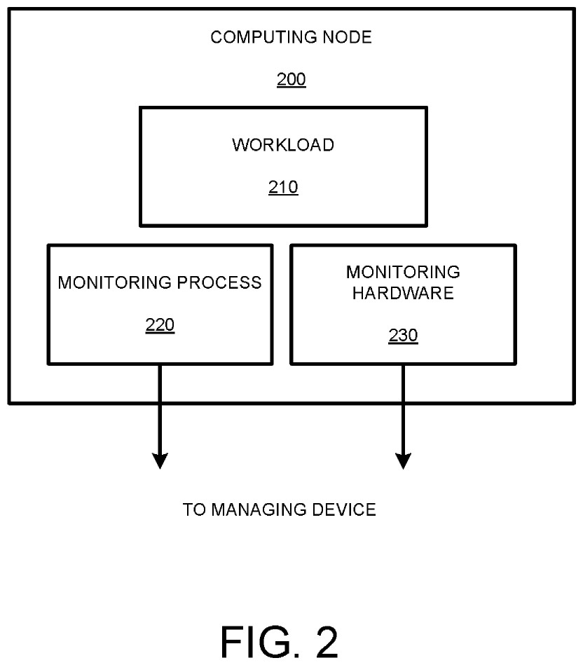

FIG. 2 is a block diagram of an example computing node 200. As shown in FIG. 2, the example computing node 200 includes a workload 210, a monitoring process 220, and monitoring hardware 230. For the purposes of FIG. 2, it may be appreciated that the workload 210 and the monitoring process 220 may take the form of various software and/or firmware routines embedded in some form of memory accessible by some form of processing device, such as a Central Processing Unit (CPU).

In operation, as the process(es) constituting the workload 210 performs some form of activity, and the monitoring (e.g., “watchdog”) process 220 may perform any number of monitoring services to assure that the workload 210 is functioning within some range of expectations. Similarly, the monitoring hardware 230 may perform any number of hardware-based checks to determine whether or not there has been some form of failure that affects the performance of the computing device. During the monitoring of the workload 210, the monitoring process 220 and the monitoring hardware 230 may send out any number of signals, such as regular “heartbeat” pulses, that may inform some form of managing device, such as the workload managing device 110 of FIG. 1, as to whether or not there is a failure associated with the computing node 200.

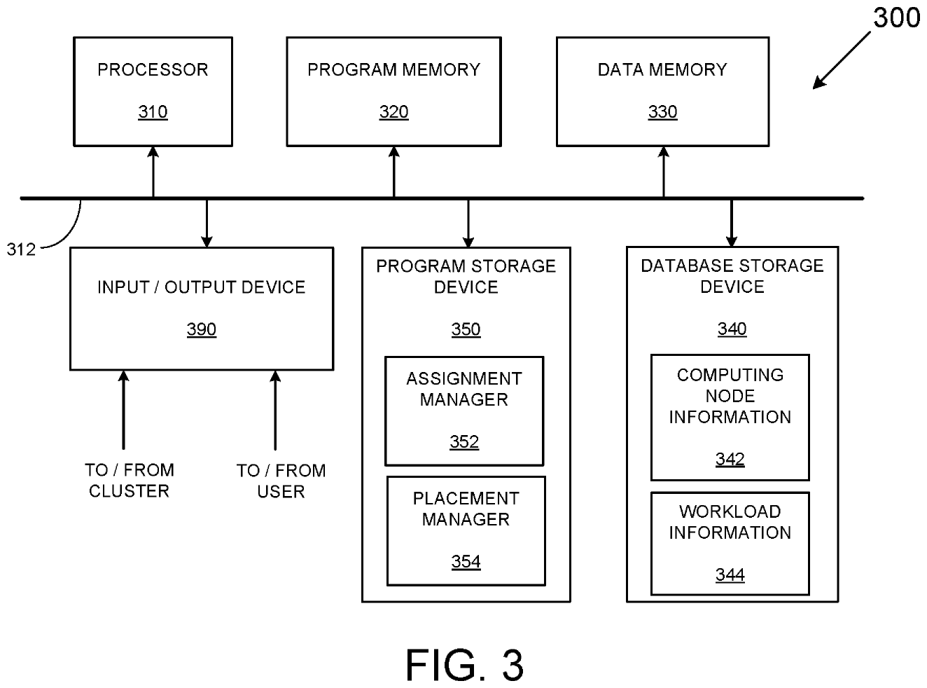

FIG. 3 is a block diagram of an example workload managing device 300 capable of managing the placement of different workloads among a cluster of computing nodes. As shown in FIG. 3, the example workload managing device 300 includes a processor 310 (e.g., a CPU), a program memory 320, a data memory 330, a database storage device 340, a program storage device 350, and an input/output device 390. The above components 310-390 are communicatively coupled together by a control/data bus 312.

Although the example workload managing device 300 of FIG. 3 uses a bused architecture, it should be appreciated that any other architecture may be used as is well. For instance, in various examples, the various components 310-390 can take the form of separate electronic components coupled together via a series of separate buses.

Still further, in other examples, one or more of the various components 310-390 can take form of separate servers coupled together via one or more networks. Additionally, it should be appreciated that each of components 310-390 advantageously can be realized using multiple computing devices employed in a cooperative fashion. For example, by employing two or more separate computing devices, e.g., servers, to provide separate processing and data-handling needs, processing bottlenecks can be reduced/eliminated, and the overall computing time may be significantly reduced.

It also should be appreciated that some processing, typically implemented in software/firmware routines residing in program memory 320, alternatively may be implemented using dedicated processing logic. Still further, some processing may be performed by software/firmware processes residing in separate memories in separate servers/computers being executed by different controllers.

In operation, the example workload managing device 300 can first perform a number of setup operations including transferring an operating system and a number of appropriate program(s) from the program storage device 350 to the program memory 320. In the present example of FIG. 3, an assignment manager 352 and a placement manager 354 are transferred from the program storage device 350 to the program memory 320 in order to allow the workload managing device 300 to control the assignment and placement of multiple workloads among a cluster of computing nodes.

In addition, setup operations may include transferring computing node information 342 and workload information 344 from the database storage device 340 to the data memory 330. In various examples, “computing node information” refers to information that describes the computing capabilities of each individual computing node managed by the workload managing device 300. Similarly, “workload information” refers to information that describes aspects about both individual workloads (e.g., peak and average computing bandwidth used) as well as describes any number of relationships between workloads. For instance, the workload information 344 of FIG. 3 may contain some form of indication as to how performance of one workload may be affected by the reduced performance of a second workload. As a more specific example, if the performance of a first workload depends heavily on information being timely provided by a second workload, but the performance of the second workload is impacted to a lesser degree based on the timeliness of information provided by the first workload, then it may be useful to create heuristic rules or weighted parameters (useful for scoring) that favor providing a relatively faster computing node to the second workload as compared to the first workload.

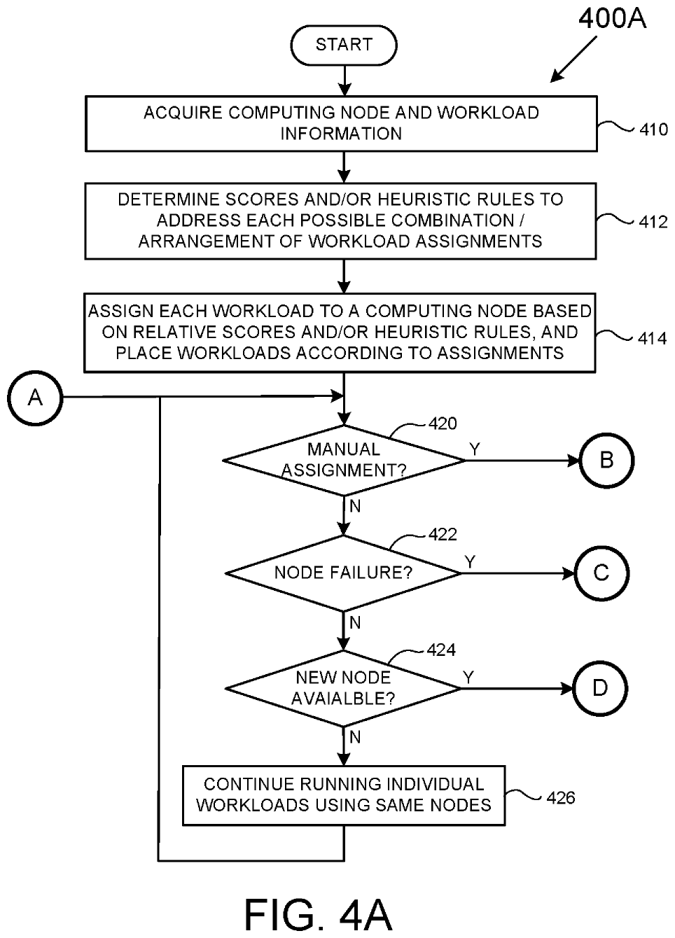

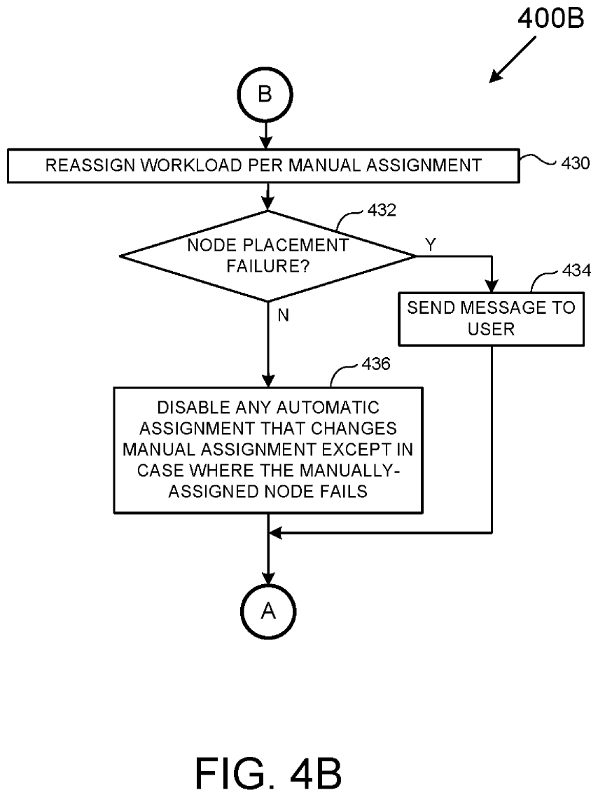

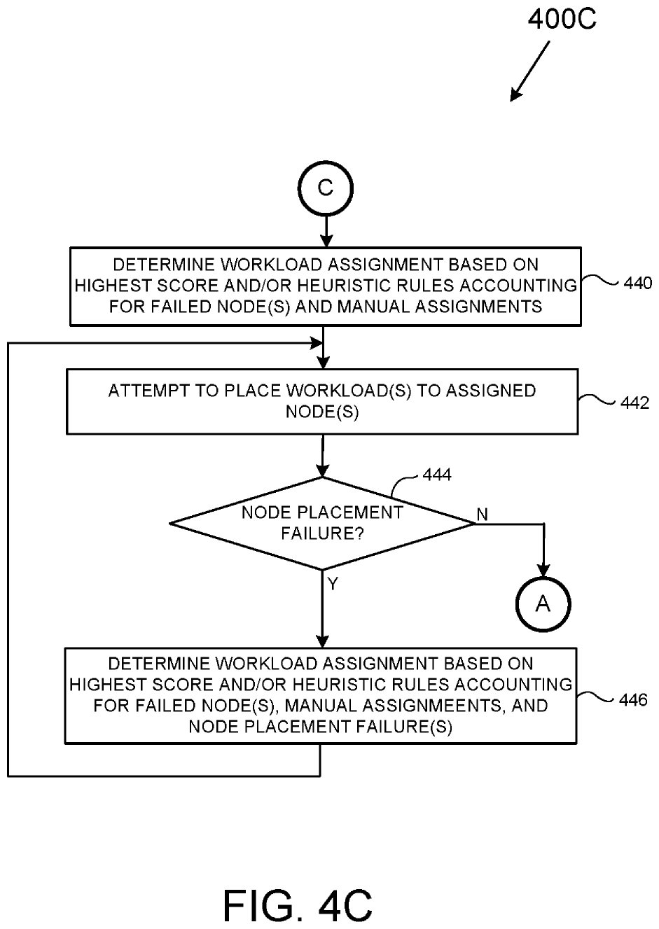

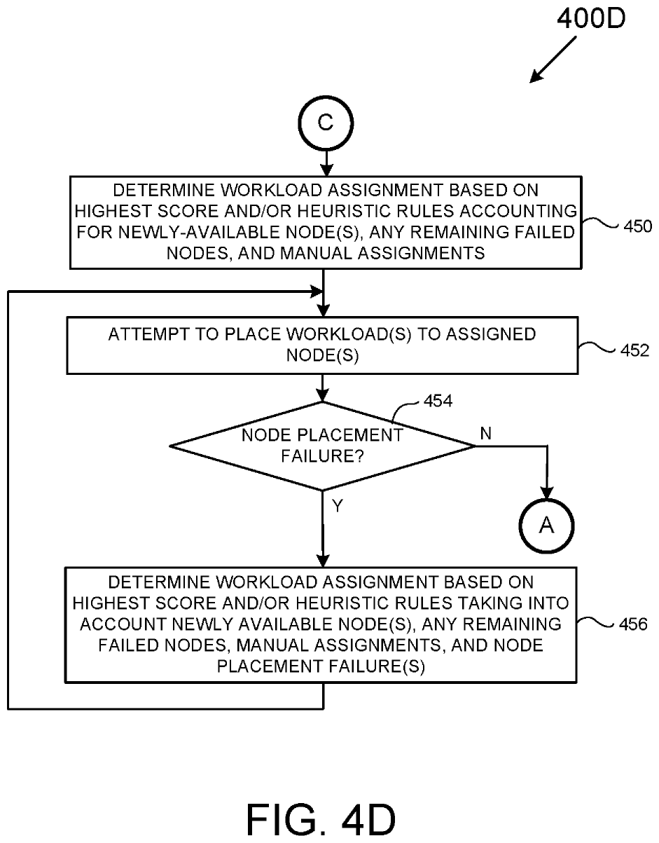

Subsequent operations of the example workload managing device 300 are discussed below with respect to FIGS. 4-13.

FIGS. 4A-4D depict interrelated flowcharts containing operations usable to manage the placement of different workloads among a cluster of computing nodes. As each flowchart of FIGS. 4A-4D provides distinct functionality, the various operations of FIGS. 4A-4D may be considered separate methods and are described as such for ease of explanation. However, because FIGS. 4A-4D also constitute a set of interrelated operations, the combined operations within FIGS. 4A-4D may also be considered to describe a single method.

FIG. 4A is a flowchart of a first method 400A useful for the initial assignment, initial placement, and general operation of workloads placed in a computing cluster of computing nodes. It is to be appreciated to those skilled in the art in light of this disclosure that, while the various operations of FIG. 4A are shown according to a particular order for ease of explanation, that certain operations may be performed in different orders or performed in a parallel fashion.

The method 400A starts in operation 410 where computing node information and workload information are acquired in some manner, e.g., received or derived. As discussed above computing node information may include information relating to any performance aspect (e.g., instructions per second), structural aspect (e.g., inclusion of a graphics processor or input/output capacity), or any other characteristic of a computing device. As is also discussed above, workload information may include information about individual workloads (e.g., computing bandwidth usage or special hardware requirements) as well as information about the relationships between workloads (e.g., processing disruption caused by latency of a particular workload).

In operation 412, a number of individual scores and/or a set of one or more heuristic rules may be determined to address each possible combination I arrangement of different workloads among different computing nodes. As discussed above the various scores may address at least one functional relationship between two workloads. Similarly, at least one heuristic rule of the set of heuristic rules may address at least one functional relationship between two workloads. As is also discussed above such individual scores and/or heuristic rules may be based upon the computing node information and workload information of operation 410, as well as based upon any number of user-provided qualifiers that may be useful or desirable (e.g., reduced on-line latency).

In operation 414, a device and/or a software process, such as the assignment manager 352 of FIG. 4, assigns each workload to a particular computing node of a computing cluster using the scores and/or heuristic rules of operation 412. Subsequently, another device and/or software process, such as the placement manager 354 of FIG. 4, places each workload into its respectively assigned computing node.

In operation 420, a determination is made as to whether a manual assignment is requested by a user (e.g., a systems or network administrator). In the present example of FIG. 4A, it is assumed that such manual assignments may not be automatically changed/countermanded by any computer-based managing device unless there is a failure of a manually-assigned computing node. However, in other examples such manual assignments may be automatically countermanded if, for example, not doing so would cause a system failure. In still other examples such manual assignments may be automatically countermanded to address any failover or failback event, i.e., a computing node fails, or a computing node becomes available again. If a manual assignment is requested then the method 400A jumps to “B” (i.e., the method 400B of FIG. 4B); otherwise, the method 400A continues to operation 422.

In operation 422, a determination is made as to whether a computing node currently being used by one or more workloads has failed resulting in a failover event. If such a computing node failure has occurred the method 400A jumps to “C” (i.e., the method 400C of FIG. 4C); otherwise, the method 400A continues to operation 424.

In operation 424, a determination is made as to whether a previously failed or otherwise unavailable computing node has become available providing a possible failback event. If such a computing node becomes available the method 400A jumps to “D” (i.e., the method 400D of FIG. 4D); otherwise, the method 400A continues to operation 426.

In operation 426, individual workloads continue to run on their previously assigned to computing nodes without reassignment, and the method 400A jumps back to operation 420 allowing operations 420-426 to be repeated as long as may be useful or desired.

FIG. 4B is a flowchart of a method 400B useful for the manual assignment of one or more workloads among a cluster of computing nodes. As with the method 400A of FIG. 4A it is to be appreciated to those skilled in the art in light of this disclosure that, while the various operations of FIG. 4B are shown according to a particular order for ease of explanation, that certain operations may be performed in different orders or performed in a parallel fashion.

The method 400B starts in operation 430 where a workload is manually reassigned to a specific computing node of a computing cluster. Next, in operation 432, a determination is made as to whether there has been a node placement failure and for some reason the manually assigned workload cannot be placed in the desired computing node. If a node placement failure has occurred, then the method 400B jumps to operation 434; otherwise, the method 400B continues to operation 436.

In operation 434 a message is sent to inform a user that the requested assignment could not be fulfilled, and the method 400B continues to “A” (i.e., the method 400A of FIG. 4A at operation 420).

In operation 436 according to the present example, any automatic assignment that changes/countermands the manual assignment is disabled except in a case where the manually-assigned computing node fails. However, as discussed above it is possible for operation 436 to vary in other examples to the point where a manual assignment may be ignored in any subsequent failover or failback event. The method 400B then continues to “A” (i.e., the method 400A of FIG. 4A at operation 420).

FIG. 4C is a flowchart of a method 400C useful for addressing a computing node failure that results in a failover event. As with the previously-described methods 400A-400B it is to be appreciated to those skilled in the art in light of this disclosure that, while the various operations of FIG. 4C are shown according to a particular order for ease of explanation, that certain operations may be performed in different orders or performed in a parallel fashion.

The method 400C starts in operation 440 where one or more workloads are reassigned to specific computing node(s) of a computing cluster using a device, such as the assignment manager 352 of FIG. 3. As discussed above, such workload reassignments may be based on a number of heuristic rules or assignment scores that address individual performance criteria and/or various relationships between workloads. It is to be appreciated that, according to the present example, such assignment(s) may take any failed nodes and manual assignments into account. That is, no assignments are made to a presently failed node and, at least for the present example, no assignment changes/countermands a manual assignment unless the computing node failure occurs in a manually-assigned computing node. Again, however, in other examples different rules may apply with respect to manually-assigned nodes. By way of example, if there is a choice between changing a manual-assignment and system failure, then it may be advisable to change/countermand such a manual assignment.

In operation 442, an attempt is made by a device, such as the placement manager 354 of FIG. 3, to place each newly-assigned workload in a respectively-assigned computing node. Next, in operation 444 a determination is made as to whether a workload placement failure has occurred. In a workload placement failure has occurred, the method 400C continues to operation 446; otherwise, the method 400C jumps to “A” (i.e., the method 400A of FIG. 4A at operation 420).

In operation 446, another workload assignment is made similar to the workload assignment of operation 440 but taking node placement failure into account by marking any computing node subject to placement failure as unavailable. The method 400C then jumps back to operation 42 where operations 442-446 may be repeated until all workloads have been successfully reassigned and placed.

FIG. 4D is a flowchart of a method 400D useful for addressing the restoration of a previously-failed computing node failure that may result in a failback event. As with the previously-described methods 400A-400C it is to be appreciated to those skilled in the art in light of this disclosure that, while the various operations of FIG. 4D are shown according to a particular order for ease of explanation, that certain operations may be performed in different orders or performed in a parallel fashion.

The method 400D starts in operation 450 where one or more workloads are reassigned to specific computing node(s) of a computing cluster using a device, such as the assignment manager 352 of FIG. 3. It is to be appreciated that, according to the present example, such assignments) may take any newly available nodes, and remaining failed nodes, and any manual assignments into account.

In operation 452 an attempt is made by a device, such as the placement manager 354 of FIG. 3, to place each newly-assigned workload in a respectively-assigned computing node. Next, in operation 454 a determination is made as to whether a workload placement failure has occurred. In a workload placement failure has occurred, the method 400D continues to operation 456; otherwise, the method 400D jumps to “A” (i.e., the method 400A of FIG. 4A at operation 420).

In operation 456 another workload assignment is made similar to the workload assignment of operation 450 but taking node placement failure into account so as to mark any computing node subject to placement failure as unavailable. The method 400D then jumps back to operation 452 where operations 452-456 may be repeated until all workloads have been successfully reassigned and placed.

Given the similarity of operations 450-456 in FIG. 4D respectively to the operations 440-466 of FIG. 4C, further discussion of operations 450-456 is omitted for the sake of brevity.

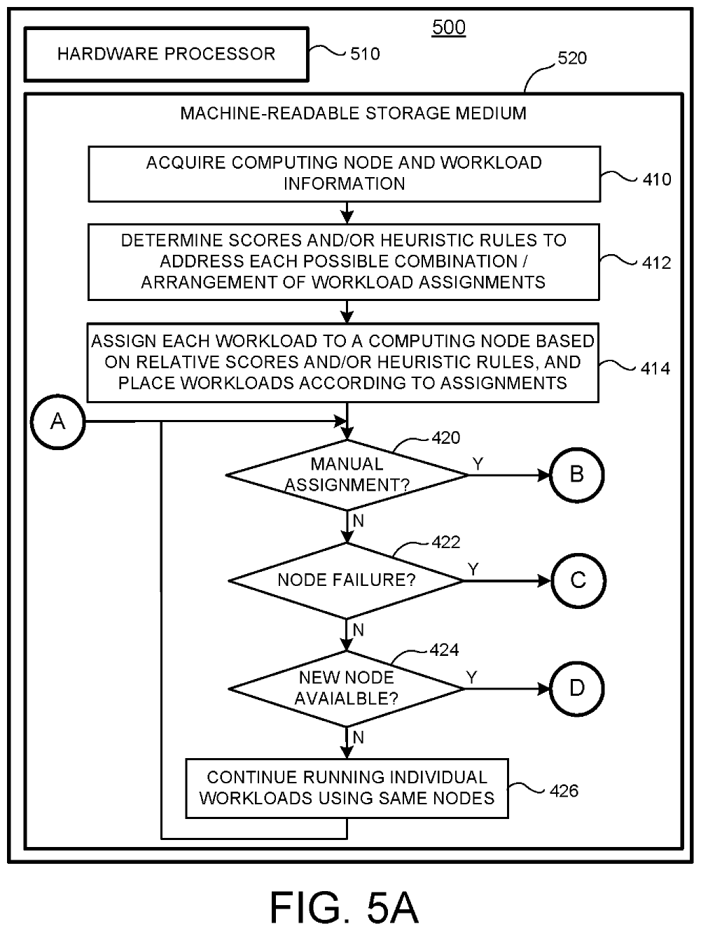

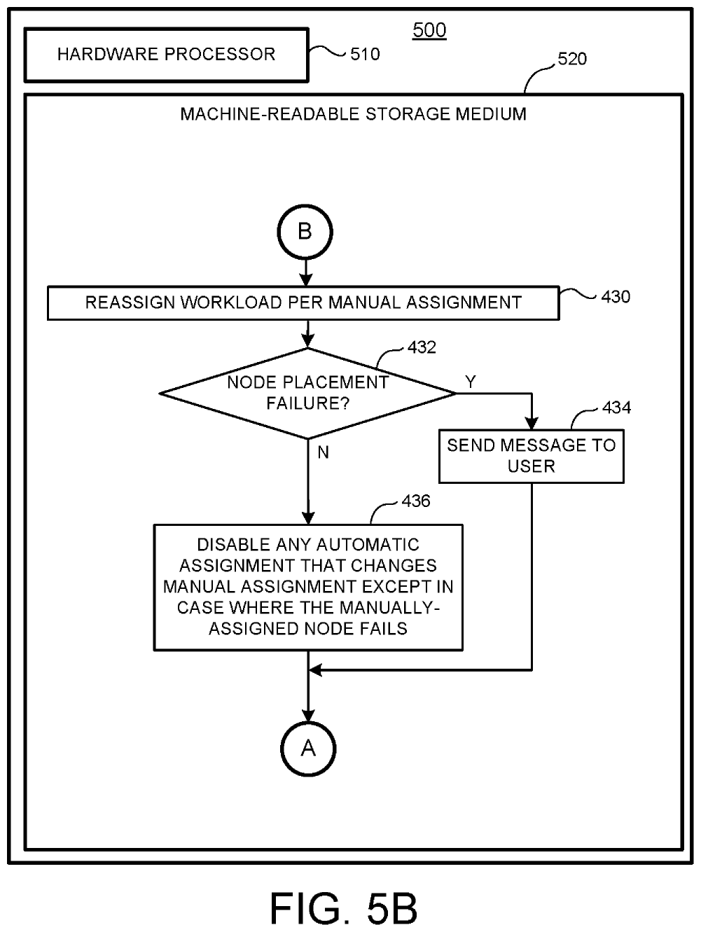

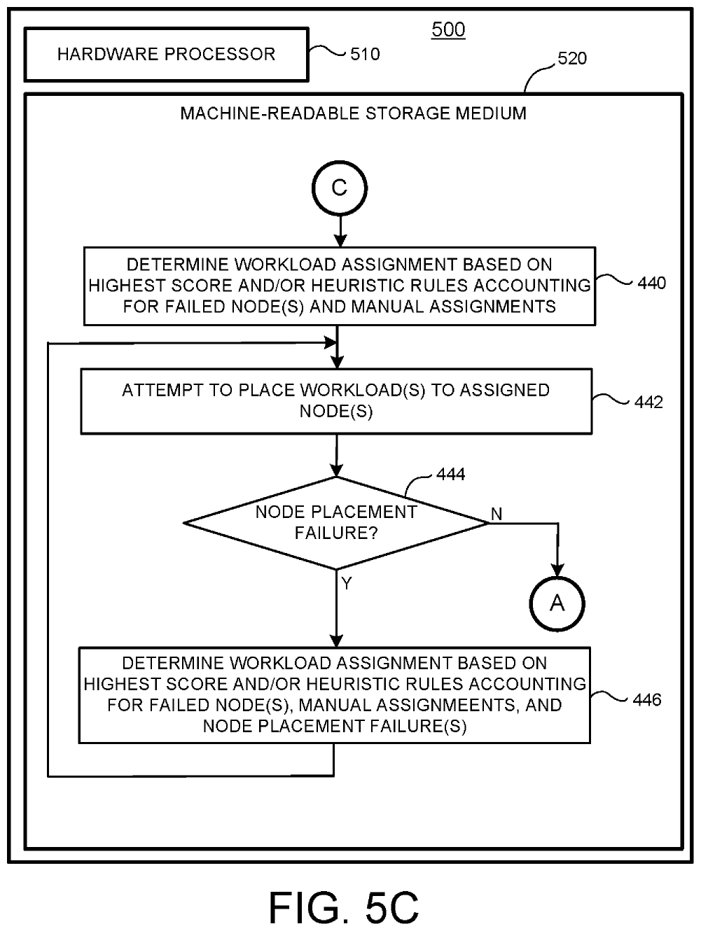

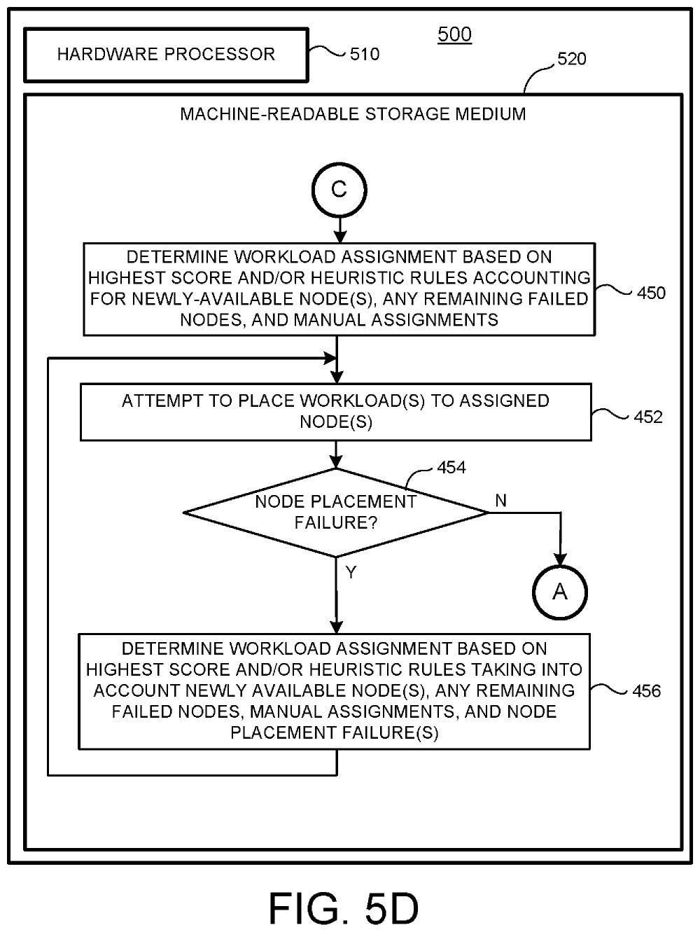

FIGS. 5A-5D depict an example device 500 that includes a hardware processor 510 communicatively coupled to a machine-readable storage medium 520 having executable instructions/computer code (shown in flowchart form) stored thereon that may be executed by the hardware processor 510. The example device 500 may take a large variety of forms including any form described for the above-discussed workload managing device 300 shown in FIG. 3. Similarly, the hardware processor 510 may take a large variety of forms including any form described for the above-discussed processor 310 shown in FIG. 3. Still further, the machine-readable storage medium 520 may take a large variety of forms including any form described for the above-discussed program memory 320 and program storage device 350 shown in FIG. 3 with an understanding that the machine-readable storage medium 520 should take a non-transitory form.

In operation, the hardware processor 510 accesses the executable instructions stored on the machine-readable storage medium 520 so as to cause the hardware processor 510 execute the executable instructions stored thereon. As the executable instructions of FIGS. 5A-5D reflect the method 400 discussed in detail above with respect to FIGS. 4A-4D, further discussion of FIGS. 5A-5D is omitted for the sake of brevity.

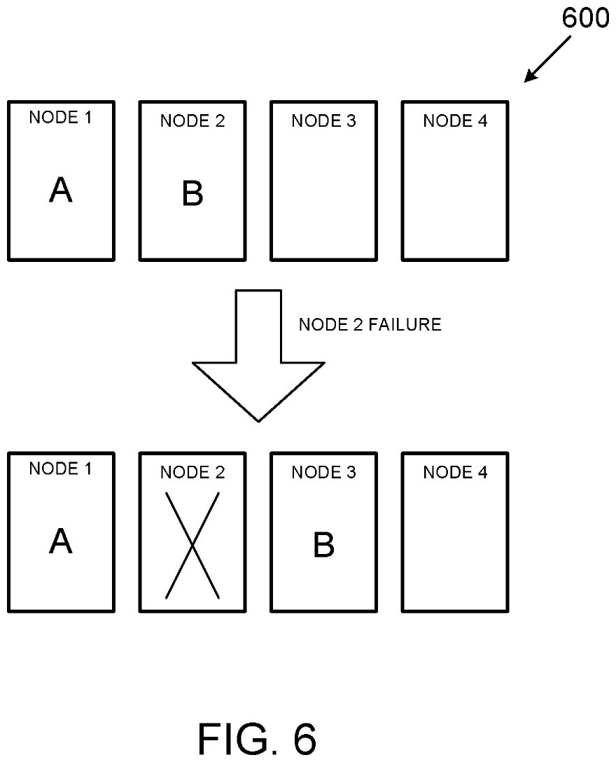

FIGS. 6-13 depict a variety of workload placement scenarios based on the disclosed methods and systems.

Starting at FIG. 6, a first scenario is depicted where a computing cluster 600 consisting of four computing nodes {Node 1 . . . Node 4} starts with a first workload A being assigned to Node 1, a second workload B being assigned to Node 1, and no workloads assigned to Node 3 or to Node 4. Assuming a failure of Node 2 (i.e., a failover event) workload B is reassigned to Node 3 with node 2 marked as failed (“X”). As discussed above, such reassignment may be accomplished used any number of heuristic rules and/or scoring criteria that at least takes one or more relationships between workloads A and B into account.

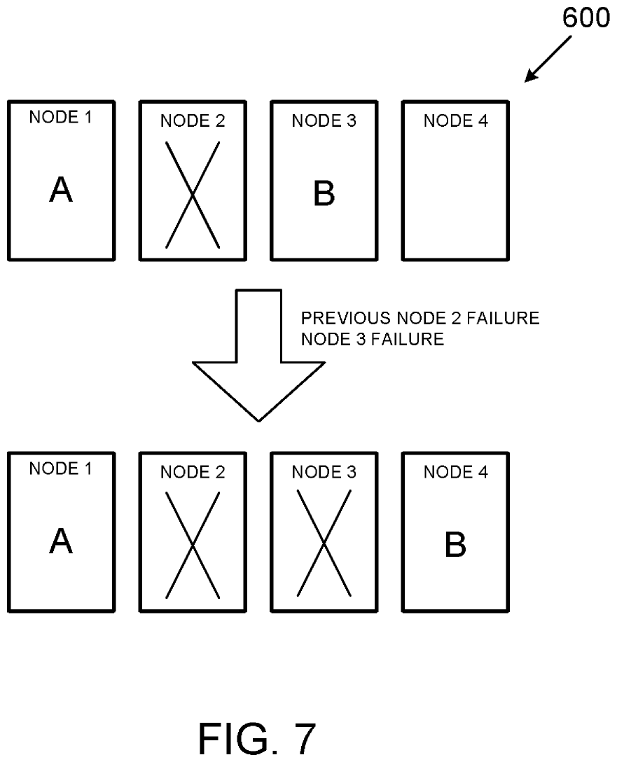

FIG. 7 adds to the scenario of FIG. 6 by assuming that Node 3 subsequently fails resulting in workload B being assigned to Node 4 while Nodes 2 and 3 are marked as failed. Again, such assignments may be accomplished used any number of heuristic rules and/or scoring criteria that at least takes one or more relationships between workloads A and B into account.

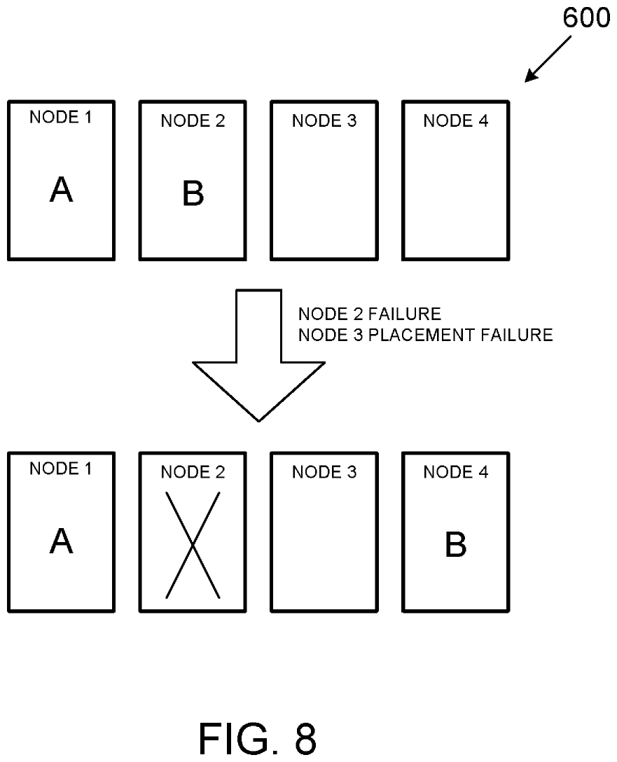

FIG. 8 is a variant of the scenario of FIG. 6 whereby Node 2 fails, and placement of workload B in Node 3 is unsuccessful thus causing workload B to be assigned to Node 4. While Node 3 is not marked failed as is Node 2, for the purposed of the failover event depicted in FIG. 8, Node 3 is nonetheless unavailable. However, unlike a failed node, it may be assumed that Node 3 is available for another failover or failback event.

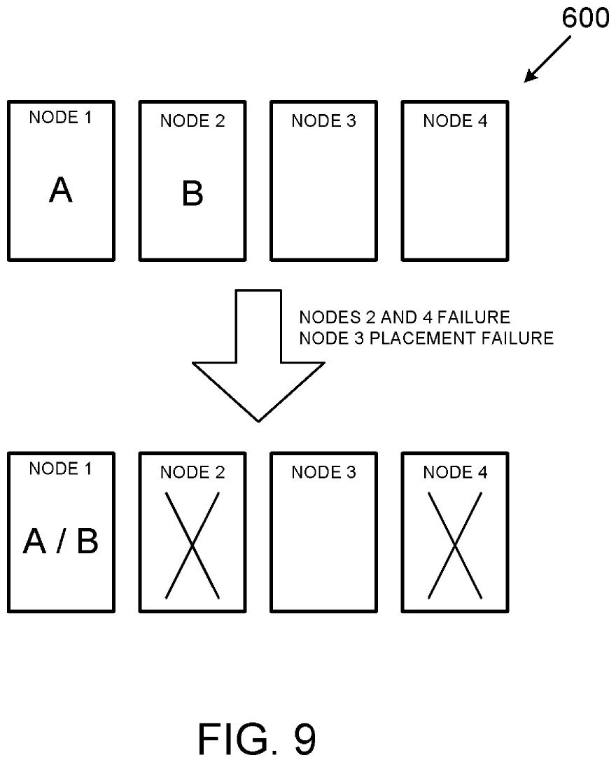

FIG. 9 is a variant of the scenario of FIG. 8 whereby Nodes 2 and 4 fail and placement of workload B in Node 3 is unsuccessful. In this scenario, workload B is assigned to Node 1 such that both workload A and workload B occupy a common Node in order to avoid to total system failure of the computing cluster 600.

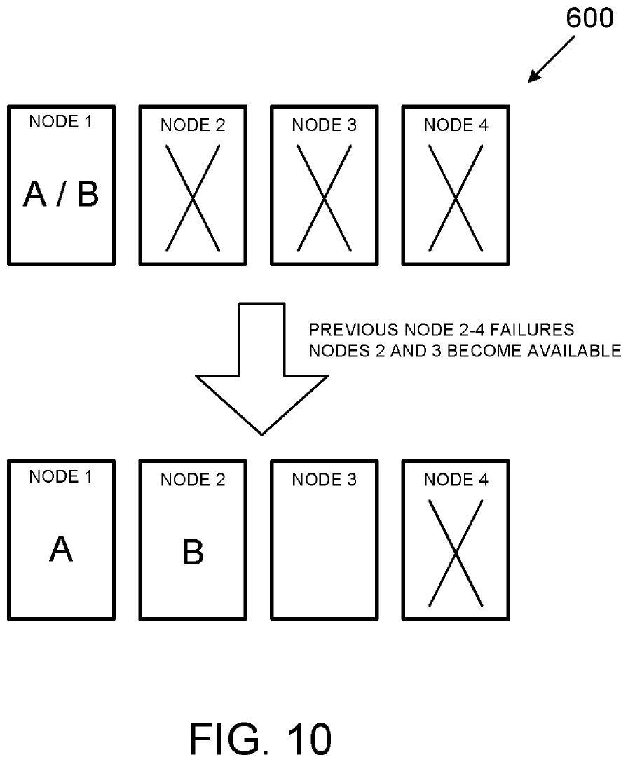

FIG. 10 depicts a failover event where previously failed Nodes 2 and 3 become available and Workload B is reassigned to Node 2 while workload A remains in Node 1.

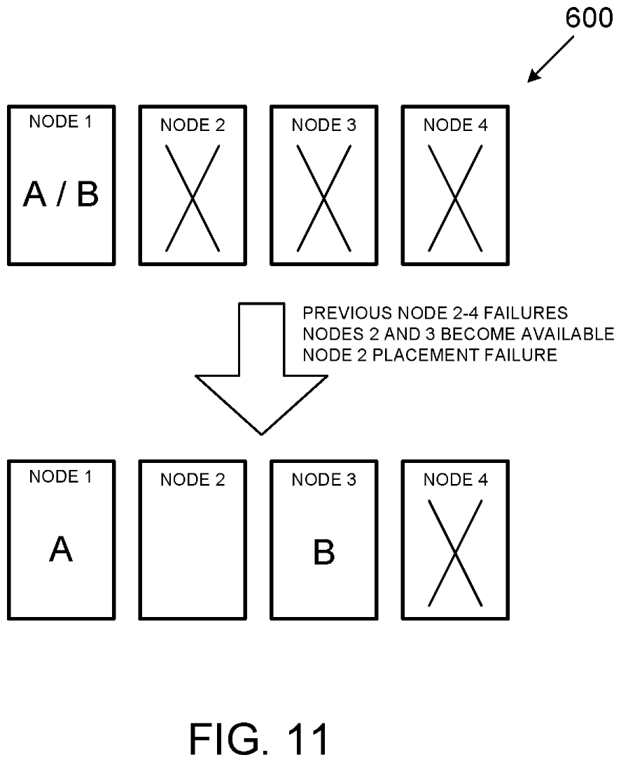

FIG. 11 depicts a variant of the failover event of FIG. 10 whereby a placement failure of workload B into Node 2 results in workload B being assigned to Node 3.

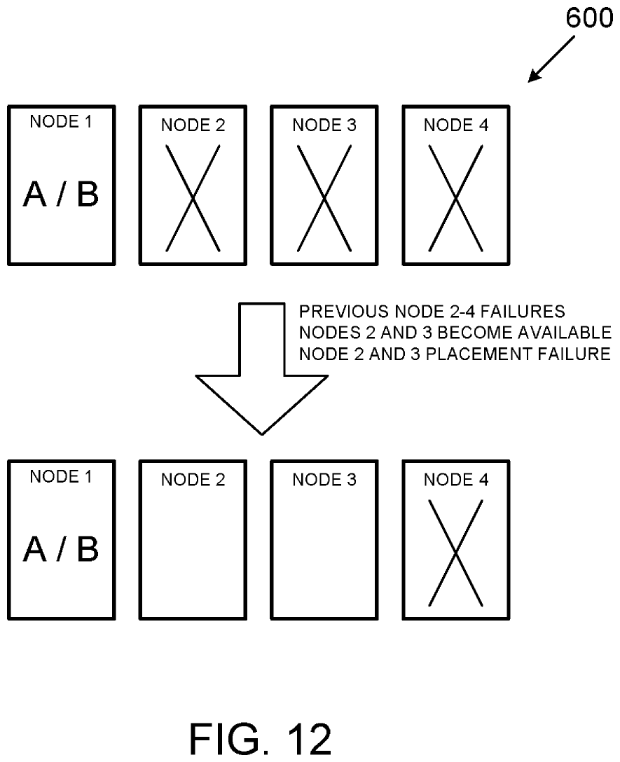

FIG. 12 depicts another variant of the failover event of FIG. 10 whereby a placement failure of workload B into both Node 2 and later Node 3 results in workload B remaining in Node 1.

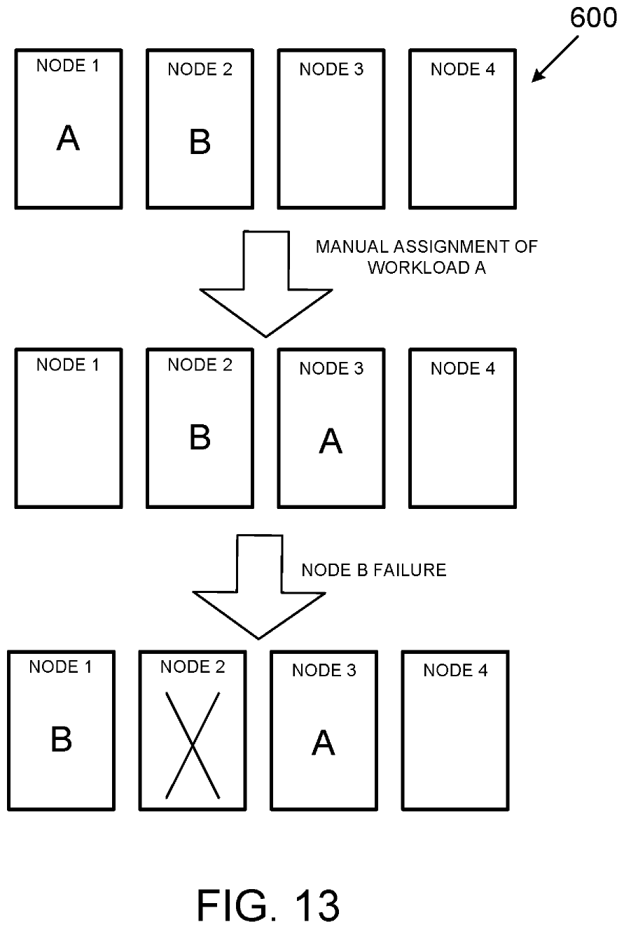

Finally, FIG. 13 depicts the possible effect of a manual assignment on a subsequent node failure (i.e., a failback event). As shown in FIG. 13, a manual assignment of workload A results in workload A being migrated to Node 3 while workload B remains in Node 2. Subsequently, a failure of Node 2 results in workload B being assigned to Node 1 while workload A remains in Node 3. This is in contrast to an automatic assignment that might otherwise place workload A in Node 1 and workload B in Node 3, which is assumed to provide a workload arrangement resulting in better system performance.

In various examples the above-described systems and/or methods may be implemented with any of a variety of circuitry. In those examples where any particular device or method is implemented using a programmable device, such as a computer-based system or programmable logic, it should be appreciated that the above-described systems and methods can be implemented using any of various known or later developed programming or scripting languages, such as “SQL,” “C,” “C++,” “FORTRAN,” Pascal,” “Python,” “VHDL” and the like.

Accordingly, various storage media, such as magnetic computer disks, optical disks, electronic memories or any other form of non-transient computer-readable storage memory, can be prepared that can contain information and instructions that can direct a device, such as a computer, to implement the above-described systems and/or methods. Such storage devices can be referred to as “computer program products” for practical purposes. Once an appropriate device has access to the information and programs contained on the storage media I computer program product, the storage media can provide the information and programs to the device, thus enabling the device to perform the above-described systems and/or methods. Unless otherwise expressly stated, “storage medium” is not an electromagnetic wave per se.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods related to database-related services.

While the methods and systems above are described in conjunction with specific examples, it is evident that many alternatives, modifications, and variations will be apparent to those skilled in the art. Accordingly, the examples above as set forth herein are intended to be illustrative, not limiting. There are changes that may be made without departing from the scope of the present disclosure.

What is claimed is:

1. A method that assigns and places at least two related workloads, including a first workload and a second workload, to one or more computing nodes in a computing cluster of at least three computing nodes, comprising:
assigning the first workload to a first computing node based upon a functional relationship between the first workload and the second workload to produce a first assignment;
assigning the second workload to a second computing node based upon the functional relationship between the first workload and the second workload to produce a second assignment; and
placing the first workload in the first computing node and placing the second workload in the first computing node based on the first and second assignments.

2. The method of claim 1, further comprising:
assigning the second workload to a third computing node based upon the functional relationship between the first workload of the second workload to produce a third assignment in response to the second computing node failing.

3. The method of claim 2, further comprising:
assigning the second workload to a fourth computing node based upon the functional relationship between the first workload of the second workload to produce a fourth assignment in response to a placement failure whereby the second workload was not placed in the third computing node; and
placing the second workload in the fourth computing node based on the fourth assignment.

4. The method of claim 2, further comprising:
assigning the second workload to the first computing node based upon the functional relationship between the first workload of the second workload to produce a fifth assignment in response to a placement failure whereby the second workload was not placed in the third computing node; and
placing the second workload in the first computing node based on the fifth assignment such that both the first workload and the second workload share the first computing node.

5. The method of claim 1, wherein:
the first assignment is based upon a relative computing bandwidth usage of the first workload as compared to the second workload.

6. The method of claim 1, wherein:
the first assignment is based is further based upon a characteristic of the first workload having no functional relationship to the second workload.

7. The method of claim 1, wherein:
the first assignment and the second assignment are based on a set of heuristic rules with at least one heuristic rule of the set of heuristic rules addressing at least one functional relationship between the first workload and the second workload.

8. The method of claim 1, wherein:
the first assignment and the second assignment are based on a set of scores with each score of the set of scores addressing at least one functional relationship between the first workload and the second workload.

9. The method of claim 1, further comprising:
assigning the second workload to a third computing node based upon the functional relationship between the first workload of the second workload to produce a third assignment in response to the third computing node recovering from a previous failure.

10. The method of claim 9, wherein the second workload is not placed in the third computing node in response to a placement failure of the second workload in the third computing node.

11. A non-transitory computer-readable medium comprising computer executable instructions stored thereon that assign and place at least two related workloads, including a first workload and a second workload, to one or more computing nodes in a computing cluster of at least three computing nodes, wherein the computer executable instructions, when executed by a processor, cause the processor to:
assign the first workload to a first computing node based upon a functional relationship between the first workload and the second workload to produce a first assignment;
assign the second workload to a second computing node based upon the functional relationship between the first workload of the second workload to produce a second assignment; and
place the first workload in the first computing node and place the second workload in the first computing node based on the first and second assignments.

12. The non-transitory computer-readable medium of claim 11, further comprising computer executable instructions that cause the processor to:
assign the second workload to a third computing node based upon the functional relationship between the first workload of the second workload to produce a third assignment in response to the second computing node failing.

13. The non-transitory computer-readable medium of claim 12, further comprising computer executable instructions that cause the processor to:
assign the second workload to a fourth computing node based upon the functional relationship between the first workload of the second workload to produce a fourth assignment in response to a placement failure whereby the second workload was not placed in the third computing node; and
place the second workload in the fourth computing node based on the fourth assignment.

14. The non-transitory computer-readable medium of claim 11, wherein:
the first assignment and the second assignment are based on a set of heuristic rules with at least one heuristic rule of the set of heuristic rules addressing at least one functional relationship between the first workload and the second workload.

15. The non-transitory computer-readable medium of claim 11, wherein:
the first assignment and the second assignment are based on a set of scores with each score of the set of scores addressing at least one functional relationship between the first workload and the second workload.

16. A system comprising:
a device that assigns and places at least two related workloads, including a first workload and a second workload, to one or more computing nodes in a computing cluster of at least three computing nodes, the device including
an assignment manager to perform a first assignment to assign the first workload to a first computing node based upon a functional relationship between the first workload and the second workload, and to further perform a second assignment to assign the second workload to a second computing node based upon the functional relationship between the first workload of the second workload; and
a placement manager that places the first workload in the first computing node and place the second workload in the first computing node based on the first and second assignments of the assignment manager.

17. The system of claim 16, wherein:
the assignment manager assigns the second workload to a third computing node based upon the functional relationship between the first workload of the second workload to produce a third assignment in response to the second computing node failing.

18. The system of claim 17, wherein:
the assignment manager assigns the second workload to a fourth computing node based upon the functional relationship between the first workload of the second workload to produce a fourth assignment in response to a placement failure whereby the second workload was not placed in the third computing node; and
the placement manager places the second workload in the fourth computing node based on the fourth assignment.

19. The system of claim 16, wherein:
the first assignment and the second assignment are based on a set of heuristic rules with at least one heuristic rule of the set of heuristic rules addressing at least one functional relationship between the first workload and the second workload.

20. The system of claim 16, wherein:
the first assignment and the second assignment are based on a set of scores with each score of the set of scores addressing at least one functional relationship between the first workload and the second workload.
